(19) United States
(12) Patent Application Publication
(10) Pub. No.: US 2026/0170649 A1
(43) Pub. Date: Jun. 18, 2026

(54) INFORMATION PROCESSING APPARATUS, INSPECTION APPARATUS, INFORMATION PROCESSING METHOD, INSPECTION METHOD, AND LEARNING METHOD

(71) Applicant: Lasertec Corporation, Yokohama (JP)

(72) Inventors: Yuki ONO, Yokohama-shi (JP); Daisuke TAKAHASHI, Yokohama-shi (JP); Sachiho OKA, Yokohama-shi (JP)

(21) Appl. No.: 19/414,101

(22) Filed: Dec. 9, 2025

(30) Foreign Application Priority Data
Dec. 13, 2024 (JP) 2024-218516

(51) Int. Cl. G06T 7/00; G06T 7/73; G06V 10/44; G06V 10/764; G06V 10/774

(52) U.S. Cl. CPC G06T 7/0014; G06T 7/74; G06V 10/44; G06V 10/764; G06V 10/774; G06T 2207/20081; G06T 2207/30148

(57) ABSTRACT

An information processing apparatus includes a learning unit configured to train a model, a captured image acquisition unit configured to acquire a captured image, a reference image generation unit configured to generate a reference image, and an evaluation unit configured to evaluate an object based on a comparison between the reference image and the captured image, in which the learning unit includes a structural representation data acquisition unit configured to acquire a plurality of pieces of structural representation data, a classification unit configured to classify the plurality of pieces of structural representation data into one of a plurality of classes, a representative position acquisition unit configured to select representative data to be representative from among the pieces of structural representation data belonging to the same class and acquire a representative position corresponding to the class, and a training unit configured to train the model.

### INCORPORATION BY REFERENCE

This application is based upon and claims the benefit of priority from Japanese patent application No. 2024-218516, filed on Dec. 13, 2024, the disclosure of which is incorporated herein in its entirety by reference for all purposes.

### BACKGROUND

The present disclosure relates to an information processing apparatus, an inspection apparatus, an information processing method, an inspection method, and a learning method.

Patent Literature 1 discloses an inspection method for comparing a captured image of a photomask manufactured based on design data with a reference image generated from the design data, thereby inspecting the photomask. The inspection method disclosed in Patent Literature 1 generates the reference image from the design data by using a machine learning model.
[Patent Literature 1] International Patent Publication No. WO 2019/216303.

### SUMMARY

The machine learning model disclosed in Patent Literature 1 may be configured or customized in accordance with an object to be inspected. Further, the machine learning model may be configured in a shorter time as a higher-accurate model. Therefore, regarding the machine learning model, it is important to appropriately and quickly select a training image to be used to train the machine learning model. It is desired to increase the accuracy of a machine learning model, to thereby increase the accuracy of inspection of an object.

The present disclosure has been made in view of the above-described problem and provides an information processing apparatus, an inspection apparatus, an information processing method, an inspection method, and a learning method by which it is possible to quickly increase the accuracy of a model that generates a reference image.

An information processing apparatus according to an aspect of the present embodiment includes: a learning unit configured to train a model; an image acquisition unit configured to acquire a captured image obtained by capturing an image of an object; a reference image generation unit configured to generate a reference image based on design data of the object; and an evaluation unit configured to evaluate the object based on a comparison between the reference image and the captured image, in which the learning unit includes: a structural representation data acquisition unit configured to acquire a plurality of pieces of structural representation data corresponding to a plurality of positions of the object; a classification unit configured to acquire features of feature vectors in the plurality of pieces of structural representation data and classify the plurality of pieces of structural representation data into one of a plurality of classes based on the features of the plurality of pieces of structural representation data; a representative position acquisition unit configured to select representative data to be representative from among the pieces of structural representation data belonging to the same class and acquire a representative position which is a position that corresponds to the object of the representative data corresponding to the class; and a training unit configured to include information based on a part of the design data corresponding to at least one of the representative positions and information based on the captured image of a part of the object corresponding to the at least one of the representative positions in the training data and then train the model, and the reference image generation unit generates the reference image based on the design data of the object and the trained model.

In the information processing apparatus, the structural representation data may be an image generated based on the design data of the object.

In the information processing apparatus, the structural representation data may be the captured image of the object.

In the information processing apparatus, the structural representation data may be vector data included in the design data of the object.

In the information processing apparatus, the feature vector may include, as the feature, at least one of a differential value of a luminance change in a predetermined direction, a direction in which luminance changes by a predetermined value or more, and an interval between pixels indicating the luminance equal to or greater than a predetermined value.

In the information processing apparatus, the representative position acquisition unit may select, as the representative data, the structural representation data closest to a position of a center of gravity in a feature vector space using a plurality of features as coordinate axes, from among the plurality of pieces of structural representation data included in the class.

In the information processing apparatus, a format and a property of the structural representation data may be the same as a format and a property of one of information based on a part of the design data corresponding to the representative position which is the training data and information based on the captured image of a part of the object corresponding to the representative position which is the training data.

In the information processing apparatus, a format and a property of the structural representation data may be different from a format and a property of each of information based on a part of the design data corresponding to the representative position which is the training data and information based on the captured image of a part of the object corresponding to the representative position which is the training data.

An inspection apparatus according to an aspect of the present embodiment includes: an image capturing apparatus configured to capture an image of the object; and the information processing apparatus described above.

An information processing method according to an aspect of the present embodiment includes steps of: training a model; acquiring a captured image obtained by capturing an image of an object; generating a reference image based on design data of the object; and evaluating the object based on a comparison between the reference image and the captured image, in which the step of training the model includes steps of: acquiring a plurality of pieces of structural representation data corresponding to a plurality of positions of the object; acquiring features of feature vectors in the plurality of pieces of structural representation data and classifying the plurality of pieces of structural representation data into one of a plurality of classes based on the features of the plurality of pieces of structural representation data; selecting representative data to be representative from among the pieces of structural representation data belonging to the same class and acquiring a representative position which is a position that corresponds to the object of the representative data corresponding to the class; and including information based on a part of the design data corresponding to at least one of the representative positions and information based on the captured image of a part of the object corresponding to the at least one of the representative positions in the training data and then training the model, and in the step of generating the reference image, the reference image is generated based on the design data of the object and the trained model.

In the information processing method, in the step of acquiring the structural representation data, the structural representation data may be an image generated based on the design data of the object.

In the information processing method, in the step of acquiring the structural representation data, the structural representation data may be the captured image of the object.

In the information processing method, in the step of acquiring the structural representation data, the structural representation data may be vector data included in the design data of the object.

In the information processing method, the feature vector may include, as the feature, at least one of a differential value of a luminance change in a predetermined direction, a direction in which luminance changes by a predetermined value or more, and an interval between pixels indicating the luminance equal to or greater than a predetermined value.

In the information processing method, in the step of acquiring the representative position, the structural representation data closest to a position of a center of gravity in a feature vector space using a plurality of features as coordinate axes may be selected as the representative data from among the plurality of pieces of structural representation data included in the class.

In the information processing method, a format and a property of the structural representation data may be the same as a format and a property of one of information based on a part of the design data corresponding to the representative position which is the training data and information based on the captured image of a part of the object corresponding to the representative position which is the training data.

In the information processing method, a format and a property of the structural representation data may be different from a format and a property of each of information based on a part of the design data corresponding to the representative position which is the training data and information based on the captured image of a part of the object corresponding to the representative position which is the training data.

An inspection method according to an aspect of the present embodiment includes steps of: capturing an image of an object; and performing information processing by using the information processing method described above.

A learning method according to an aspect of the present embodiment includes steps of: acquiring a plurality of pieces of structural representation data corresponding to a plurality of positions of an object; acquiring features of feature vectors in the plurality of pieces of structural representation data and classifying the plurality of pieces of structural representation data into one of a plurality of classes based on the features of the plurality of pieces of structural representation data; selecting representative data to be representative from among the pieces of structural representation data belonging to the same class and acquiring a representative position which is a position that corresponds to the object of the representative data corresponding to the class; and including information based on a part of the design data of the object corresponding to at least one of the representative positions and information based on the captured image of a part of the object corresponding to the at least one of the representative positions in the training data and then training a model.

In the learning method, in the step of acquiring the structural representation data, the structural representation data may be an image generated based on the design data of the object.

In the learning method, in the step of acquiring the structural representation data, the structural representation data may be the captured image of the object.

In the learning method, in the step of acquiring the structural representation data, the structural representation data may be vector data included in the design data of the object.

In the learning method, the feature vector may include, as the feature, at least one of a differential value of a luminance change in a predetermined direction, a direction in which luminance changes by a predetermined value or more, and an interval between pixels indicating the luminance equal to or greater than a predetermined value.

In the learning method, in the step of acquiring the representative position, the structural representation data closest to a position of a center of gravity in a feature vector space using a plurality of features as coordinate axes may be selected as the representative data from among the plurality of pieces of structural representation data included in the class.

In the learning method, a format and a property of the structural representation data may be the same as a format and a property of one of information based on a part of the design data corresponding to the representative position which is the training data and information based on the captured image of a part of the object corresponding to the representative position which is the training data.

In the learning method, a format and a property of the structural representation data may be different from a format and a property of each of information based on a part of the design data corresponding to the representative position which is the training data and information based on the captured image of a part of the object corresponding to the representative position which is the training data.

According to the present disclosure, an information processing apparatus, an inspection apparatus, an information processing method, an inspection method, and a learning method by which it is possible to increase accuracy are provided.

The above and other objects, features and advantages of the present disclosure will become more fully understood from the detailed description given herein below and the accompanying drawings.

### BRIEF DESCRIPTION OF DRAWINGS

FIG. 1 is a schematic diagram illustrating an inspection apparatus according to a first embodiment;

FIG. 2 is a schematic diagram illustrating an outline of an auto calibration point pickup function in the inspection apparatus according to the first embodiment;

FIG. 3 is a configuration diagram illustrating an image capturing apparatus in the inspection apparatus according to the first embodiment;

FIG. 4 is a configuration diagram illustrating another image capturing apparatus in the inspection apparatus according to the first embodiment;

FIG. 5 is a block diagram illustrating a configuration of an information processing apparatus in the inspection apparatus according to the first embodiment;

FIG. 6 is a diagram illustrating structural representation data generated by a structural representation data acquisition unit in the information processing apparatus according to the first embodiment;

FIG. 7 is a diagram illustrating feature vectors of structural representation data distributed on a feature vector space by a classification unit in the information processing apparatus according to the first embodiment;

FIG. 8 is a diagram illustrating classification of structural representation data performed by the classification unit in the information processing apparatus according to the first embodiment;

FIG. 9 is a diagram illustrating selection of a representative position performed by a representative position acquisition unit of the information processing apparatus according to the first embodiment;

FIG. 10 is a flowchart illustrating an information processing method using the information processing apparatus according to the first embodiment;

FIG. 11 is a flowchart illustrating a learning method using a learning unit in the information processing apparatus according to the first embodiment; and

FIG. 12 is a flowchart illustrating an inspection method according to the first embodiment.

### DESCRIPTION OF EMBODIMENTS

Embodiments of the present disclosure will be described hereinafter with reference to the drawings. The following description shows embodiments of the present disclosure, and the scope of the present disclosure is not limited to the following embodiments. In the following description, elements denoted by the same reference numerals or symbols indicate substantially similar contents. In the drawings, some reference numerals or symbols may be omitted for the sake of brevity.

### First Embodiment

A first embodiment will be described. First, an <inspection apparatus> will be described, and then an <image capturing apparatus> and an <information processing apparatus> in the inspection apparatus will be described. Then, after an <information processing method> and a <learning method> are described, an <inspection method> will be described.

### Inspection Apparatus

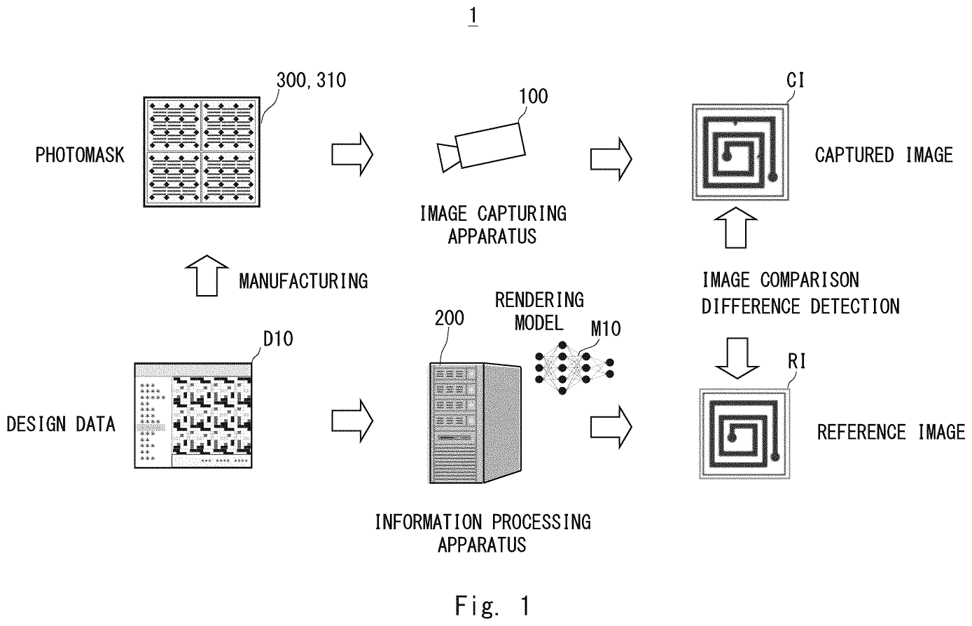

An inspection apparatus according to the first embodiment will be described. FIG. 1 is a schematic diagram illustrating an inspection apparatus 1 according to the first embodiment. As shown in FIG. 1, the inspection apparatus 1 according to this embodiment includes an image capturing apparatus 100 and an information processing apparatus 200. In FIG. 1, the image capturing apparatus 100 and the information processing apparatus 200 are shown separately. However, in the inspection apparatus 1, the information processing apparatus 200 may be integrated into the image capturing apparatus 100, or the image capturing apparatus 100 and the information processing apparatus 200 may each function as a single unit.

The inspection apparatus 1 according to this embodiment inspects an object 300. The inspection apparatus 1 inspects, for example, a defect present in the object 300. The object 300 may be an Extreme Ultra Violet (EUV) photomask used in lithography using EUV light. The EUV photomask is simply referred to as an EUV mask 310. Further, the object 300 may be a photomask used in lithography using light other than EUV light. Note that the object 300 is not limited to a photomask, and may instead be a semiconductor substrate and a semiconductor apparatus as long as patterns are formed.

In the following description, the object 300 may be described as the EUV mask 310, as an example, as appropriate. In this case, the inspection apparatus 1 is an EUV mask inspection apparatus which inspects the EUV mask 310. The inspection apparatus 1 inspects the EUV mask 310 by capturing a captured image CI of the EUV mask 310 including patterns and comparing the captured image CI with a reference image RI. An outline of inspection performed by the inspection apparatus 1 will be described below.
(1) First, the inspection apparatus 1 converts design data D10 of the EUV mask 310 into the reference image RI. The design data D10 may include design Computer Aided Design (CAD) data. Further, the design data D10 may include vector data. The process of converting the design data D10 into the reference image RI is referred to as Rendering.
(2) Next, the inspection apparatus 1 captures an image of the EUV mask 310 by using the image capturing apparatus 100, thereby acquiring the captured image CI. Then the inspection apparatus 1 compares the reference image RI with the captured image CI and detects a difference between them. The inspection apparatus 1 detects a defect in the EUV mask 310 from the difference acquired by comparing the images.

In this embodiment, the inspection apparatus 1, before performing the above (1), generates a rendering model M10 (a converter), which performs conversion processing, and trains the rendering model M10. The rendering model M10 may be simply referred to as a model. The rendering model M10 is generated and trained by using a machine learning technique. One of the features of this embodiment is that a position (a calibration point) on the EUV mask 310 serving as training data for performing machine learning on the rendering model M10 is automatically selected.

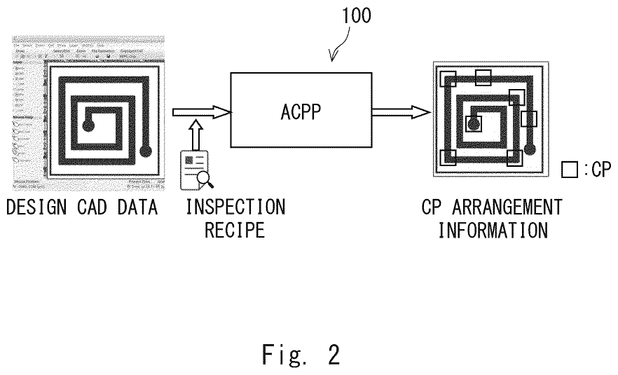

FIG. 2 is a schematic diagram illustrating an outline of an Auto Calibration Point Pickup (hereinafter referred to as ACPP) function in the inspection apparatus 1 according to the first embodiment. As shown in FIG. 2, the inspection apparatus 1 according to this embodiment has an ACPP function. When the design data D10 of the EUV mask 310 and an inspection recipe specifying an inspection target range are input, the inspection apparatus 1 outputs a calibration point CP on the EUV mask 310 suitable for training the rendering model M10. Thus, it is possible to increase the speed and the accuracy of generation and training of the rendering model M10.

It should be noted that, in order to create the rendering model M10 having a sufficient drawing accuracy, it is required to appropriately select the calibration point CP as a basic element with which a pattern shape on the object 300 can be reconstructed and collect data in this calibration point CP. However, in terms of time and cost, it is not preferable to perform the above selection of the calibration point CP and the collection of data for it by user's visual confirmation and manual operation.

Therefore, in this embodiment, the calibration point CP of the rendering model M10 is automatically selected and data used for training is automatically collected. Therefore, in this embodiment, the required minimum number of the calibration points CP is selected in such a manner that variations of the pattern shape on the object 300 such as a photomask are covered by using an image feature extraction technique and a statistical analysis technique.

Specifically, as an example, the inspection apparatus 1 according to this embodiment first arranges a plurality of positions on the object 300 to be candidates for the calibration points CP on the object 300. Then the inspection apparatus 1 collects, as structural representation data, a pattern image in which the design data D10 described as vector data is imaged (e.g., rasterized) in each of the candidate positions.

Next, the inspection apparatus 1 extracts feature vectors that numerically represent the pattern shape of the object 300 from the pattern images. Then the inspection apparatus 1 classifies a set of the extracted feature vectors by applying clustering processing as an example. The inspection apparatus 1 finds grouping in which pattern images having similar feature vectors are grouped into one class and patterns having feature vectors that greatly differ from each other belong to different classes.

The inspection apparatus 1 selects representative data from each of the classes formed as described above and outputs positions on the object 300 corresponding to the representative data as the calibration points CP. As described above, the inspection apparatus 1 has an ACPP function. The configurations of the <image capturing apparatus> and the <information processing apparatus> in the inspection apparatus 1 according to this embodiment will be described below.

### Image Capturing Apparatus

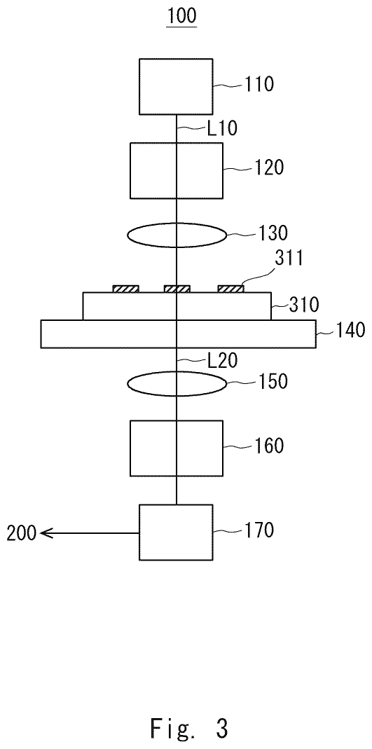

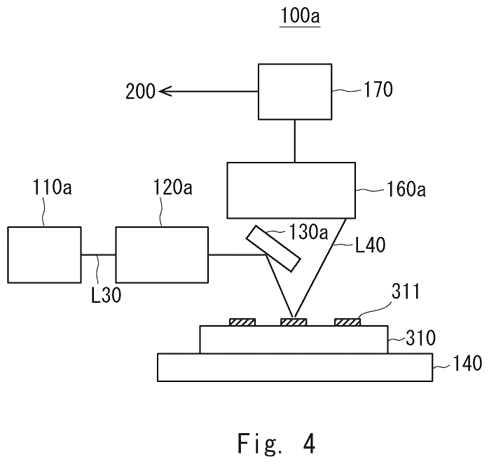

First, the image capturing apparatus 100 will be described with reference to the drawings. FIG. 3 is a configuration diagram illustrating the image capturing apparatus 100 in the inspection apparatus 1 according to the first embodiment. FIG. 4 is a configuration diagram illustrating another image capturing apparatus 100a in the inspection apparatus 1 according to the first embodiment. As shown in FIG. 3, the image capturing apparatus 100 may capture an image of the EUV mask 310 using transmitted illumination. Further, as shown in FIG. 4, the image capturing apparatus 100a may capture an image of the EUV mask 310 using reflected illumination. As shown in FIG. 3, the image capturing apparatus 100 includes an illumination light source 110, an illumination optical system 120, a lens 130, a stage 140, a lens 150, a detection optical system 160, and a detector 170.

In the following description, the EUV mask 310 provided with patterns 311 will be used as the object 300. However, the object 300 is not limited to the EUV mask 310 as long as the patterns 311 are provided, and a mask used for lithography other than EUV light provided with the patterns 311, a semiconductor substrate and a semiconductor apparatus, or the like may instead be used.

The illumination light source 110 generates illumination light L10 which illuminates the EUV mask 310. The illumination light L10 from the illumination light source 110 is incident on the illumination optical system 120. The illumination optical system 120 includes optical components such as a relay lens and a mirror, and guides the illumination light L10 to the lens 130. The illumination optical system 120 may also include an optical scanner, an autofocus (AF) function, or the like. The illumination light L10 is condensed by the lens 130 and is incident on the EUV mask 310. The lens 130 condenses the illumination light L10 on a pattern surface of the EUV mask 310 on which the patterns 311 are formed. In this way, the EUV mask 310 is illuminated.

Transmitted light L20 transmitted through the EUV mask 310 transmits through the stage 140, which is transparent to the transmitted light L20, and is incident on the lens 150. The lens 150 is an objective lens and condenses the transmitted light L20 from the EUV mask 310. The transmitted light L20 is incident on the detection optical system 160 through the lens 150. The detection optical system 160 includes optical components such as an imaging lens and a mirror, and guides the transmitted light L20 to the detector 170. The detection optical system 160 forms an image of the EUV mask 310 on a light receiving surface of the detector 170.

The detector 170 is a line sensor or a two-dimensional array sensor such as a Charged Coupled Device (CCD) or a Complementary Metal Oxide Semiconductor (CMOS) camera including a plurality of pixels. A Time Delay Integration (TDI) sensor can also be used as the detector 170. Therefore, the detector 170 captures an image of the EUV mask 310 provided with the patterns 311. The reflectance and the transmittance with regard to the illumination light L10 differ depending on whether or not the patterns 311 are present. For example, in the case of the EUV mask 310, the transmittance is low at an area where the patterns 311 are present, while the transmittance is high at an area where the patterns are not present. Therefore, the amount of received light varies depending on whether or not the patterns 311 are present. Note that the magnitude of the transmittance depending on whether or not the patterns are present is merely an example, and there may be an opposite case.

The EUV mask 310 is placed on the stage 140. The stage 140 is an XY stage and moves the EUV mask 310 in an X-axis direction and a Y-axis direction. The moving coordinates of the stage 140 are input to the information processing apparatus 200. Then, while the stage 140 moves the EUV mask 310, the detector 170 captures an image of the EUV mask 310. By doing so, the captured image CI of the entire EUV mask 310 or a desired region of the EUV mask 310 can be obtained. Since the transmittance with regard to the illumination light L10 differs depending on whether or not the patterns 311 are present, a luminance value, i.e., an intensity of a detection signal differs depending on whether or not the patterns 311 are present.

The detector 170 outputs the detection signal corresponding to the amount of received light to the information processing apparatus 200. By doing so, the captured image CI is input to the information processing apparatus 200. A gradation value corresponding to the amount of received light is set for each pixel of the captured image CI. The information processing apparatus 200 performs image processing on the detection signal. For example, the information processing apparatus 200 is a computer including a processor, a memory, and the like, as will be described later.

Note that, as shown in FIG. 4, the image capturing apparatus 100a may capture an image of the EUV mask 310 by using reflected illumination. The image capturing apparatus 100a includes an illumination light source 110a, an illumination optical system 120a, a mirror 130a, the stage 140, a detection optical system 160a, and the detector 170. When the EUV mask 310 is illuminated by light having a wavelength in the EUV region as illumination light L30 and an image of the EUV mask 310 is captured, the image capturing apparatus 100a is optionally configured as a reflection optical system.

The illumination light source 110a generates the illumination light L30 which illuminates the EUV mask 310. The illumination light L30 from the illumination light source 110a is incident on the illumination optical system 120a. The illumination optical system 120a includes optical components such as an elliptical reflecting mirror, and guides the illumination light L30 to the mirror 130a. The illumination optical system 120a may include an optical scanner, an AF function, or the like. The illumination light L30 is reflected by the mirror 130a and is incident on the EUV mask 310. The mirror 130a condenses the illumination light L30 on the pattern surface of the EUV mask 310 on which the patterns 311 are formed. In this way, the EUV mask 310 is illuminated.

Reflected light L40 reflected by the EUV mask 310 is incident on the detection optical system 160a. The detection optical system 160a includes optical components such as a reflecting mirror, and guides the reflected light L40 to the detector 170. The detection optical system 160a forms an image of the EUV mask 310 on a light receiving surface of the detector 170. The detector 170 outputs a detection signal corresponding to the amount of received light to the information processing apparatus 200. By doing so, the captured image CI is input to the information processing apparatus 200.

### Information Processing Apparatus

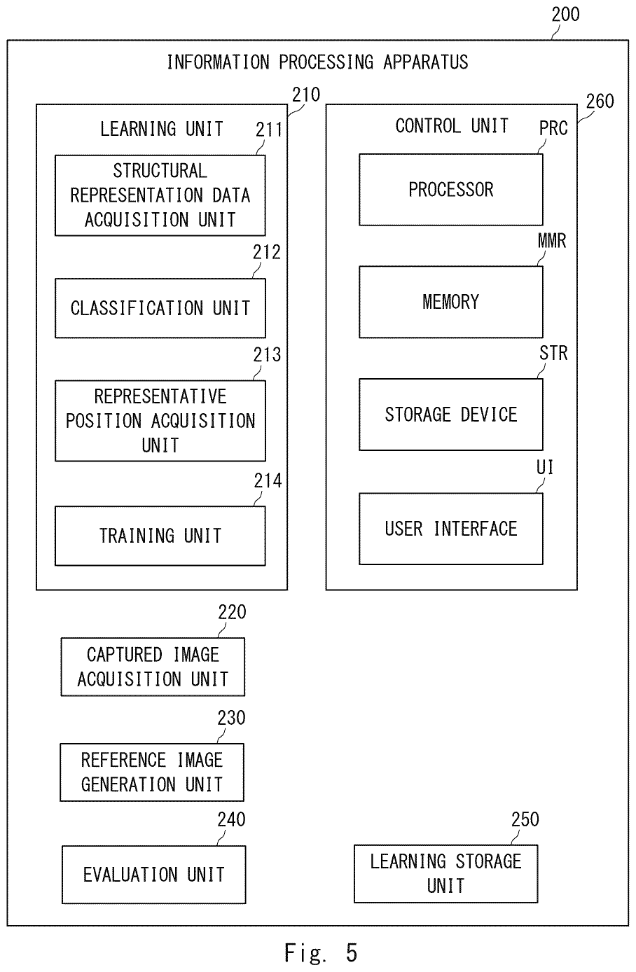

FIG. 5 is a block diagram illustrating a configuration of the information processing apparatus 200 in the inspection apparatus 1 according to the first embodiment. As shown in FIG. 5, the information processing apparatus 200 includes a learning unit 210, a captured image acquisition unit 220, a reference image generation unit 230, an evaluation unit 240, a learning storage unit 250, and a control unit 260. The learning unit 210 includes a structural representation data acquisition unit 211, a classification unit 212, a representative position acquisition unit 213, and a training unit 214. The control unit 260 includes a processor PRC, a memory MMR, a storage device STR, and a user interface UI. The information processing apparatus 200 includes an information processing device such as a Personal Computer (PC), a server, or a tablet.

First, the functions of the control unit 260 will be described. The storage device STR stores a program of processing to be executed by each component of the information processing apparatus 200. The processor PRC loads the program from the storage device STR into the memory MMR and executes the loaded program. In this way, the processor PRC implements the functions of each of the components in the information processing apparatus 200 such as the learning unit 210, the captured image acquisition unit 220, the reference image generation unit 230, and the evaluation unit 240. The user interface UI may include an input device such as a keyboard, a mouse, and an image capturing device, and an output device such as a display, a printer, and a speaker.

Each of the components of the information processing apparatus 200 may be implemented by dedicated hardware. Some or all of the components may be implemented by a general-purpose or dedicated circuitry, the processor PRC, or the like, or a combination thereof. These components may be configured by a single chip or a plurality of chips connected through a bus. Some or all of the components may be implemented by a combination of the above-described circuitry, the processor PRC, or the like and the program. A Central Processing Unit (CPU), a Graphics Processing Unit (GPU), a Field-programmable Gate Array (FPGA), a quantum processor (quantum computer control chip), or the like may be used as the processor PRC.

Further, when some or all of the components of the information processing apparatus 200 are implemented by a plurality of information processing devices, circuits, or the like, the plurality of information processing devices, circuits, or the like may be disposed in one place in a concentrated manner or arranged in a discrete manner. For example, the information processing devices, circuits, or the like may be implemented by a client-server system, a cloud computing system, or the like in a form in which they are connected to each other through a communication network. Further, the functions of the information processing apparatus 200 may be provided in the form of Software as a Service (SaaS).

The learning unit 210 trains the rendering model M10. The rendering model M10 may be an image generation model which generates the reference image RI from the design data D10. The learning unit 210 operates the structural representation data acquisition unit 211, the classification unit 212, the representative position acquisition unit 213, and the training unit 214, thereby training the rendering model M10. The rendering model M10 includes a conversion function generated by machine learning using information based on the part of the design data D10 corresponding to the representative position and information based on the captured image CI of the part of the object 300 corresponding to the representative position as training data. The rendering model M10 includes a conversion function for generating the reference image RI from the design data D10.

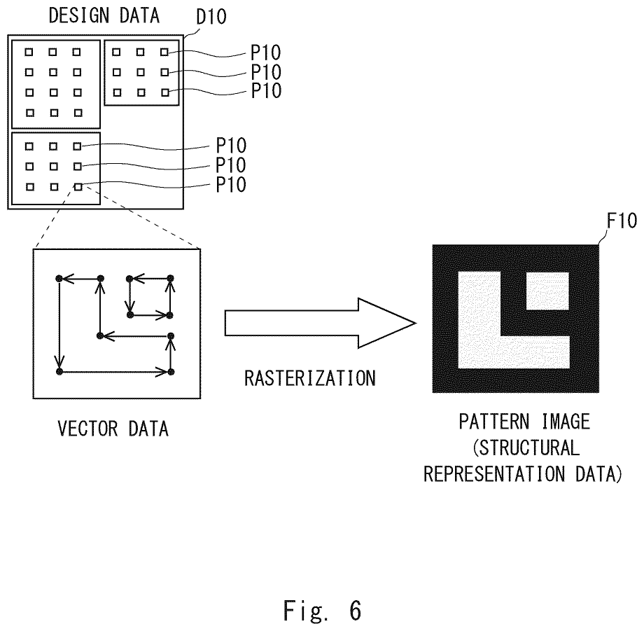

FIG. 6 is a diagram illustrating structural representation data acquired by the structural representation data acquisition unit 211 in the information processing apparatus 200 according to the first embodiment. As shown in FIG. 6, the structural representation data acquisition unit 211 acquires a plurality of pieces of structural representation data corresponding to a plurality of positions P10 in the design data D10 of the object 300. For example, the structural representation data acquisition unit 211 acquires a plurality of pattern images F10 corresponding to a plurality of positions P10 of the object 300 as the structural representation data based on the design data D10 of the object 300. Specifically, the structural representation data acquisition unit 211 generates the plurality of pattern images F10 corresponding to a plurality of positions P10 by rasterizing vector data of the parts of the design data D10 corresponding to the plurality of positions P10 of the object 300 and acquires them. That is, the structural representation data acquisition unit 211 converts the design data D10 such as design CAD data expressed by vector data into the pattern images F10 on which image processing can be performed. In this way, the structural representation data acquisition unit 211 generates the plurality of pattern images F10 as a plurality of pieces of structural representation data based on the design data D10 and acquires them. In the following description, it is assumed that the structural representation data acquisition unit 211 acquires N pattern images F10 (F11 to F1N) associated with N positions of the object 300 as a plurality of pieces of structural representation data.

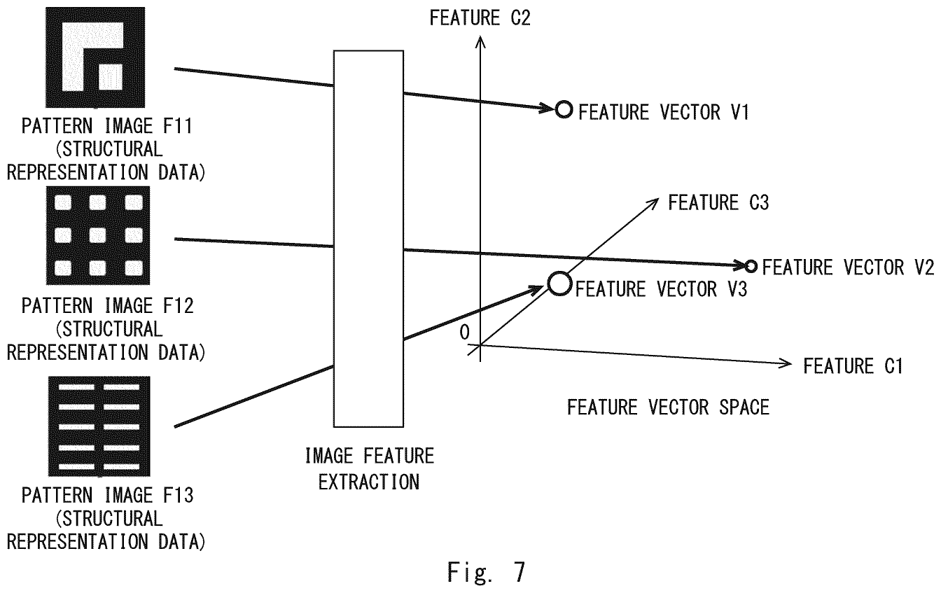

The classification unit 212 classifies a plurality of pieces of structural representation data into one of a plurality of classes. The classification procedure will be described below with reference to an example of a case where clustering processing is applied. FIG. 7 is a diagram illustrating feature vectors V1 to V3 of the feature vectors V1 to VN of the structural representation data distributed on a feature vector space by the classification unit 212 in the information processing apparatus 200 according to the first embodiment. As shown in FIG. 7, first, the classification unit 212 acquires features of a plurality of pieces of structural representation data. In other words, the classification unit 212 acquires features of the feature vectors V1 to VN in a plurality of pieces of structural representation data. In this way, when the pieces of structural representation data are N pattern images F10 (F11 to F1N) generated from a plurality of positions P10 in the design data D10, the classification unit 212 may acquire features of the feature vectors V1 to VN in a plurality of the pattern images F10 (F11 to F1N).

Next, the classification unit 212 executes clustering processing based on the features of a plurality of pieces of structural representation data. Specifically, the classification unit 212 executes clustering processing based on the features of a plurality of pattern images F10. For example, the classification unit 212 extracts the features of the feature vectors V1 to VN of the pattern images F11 to F1N, which are pieces of the structural representation data, by using an image feature extraction function. Then the classification unit 212 maps the extracted feature vectors V1 to VN on a feature vector space. The classification unit 212 maps the extracted feature vectors V1 to VN on the feature vector space by using features C1 to C3 corresponding to respective coordinate axis components of the feature vectors V1 to VN in the pattern images F11 to F1N which are pieces of the structural representation data. That is, the classification unit 212 converts each of the pattern images F11 to F1N generated by the rasterization into one point on a high-dimensional feature vector space.

The feature vector space is a space using the features C1, C2, and C3 and the like as coordinate axes. Although the number of features is three, e.g., C1 to C3, it is merely an example. The number of features may be two or less or four or more. The feature vector space is not limited to a three-dimensional space, and has as many dimensions as the number of features. The feature is a numerical value acquired by performing a predetermined numerical operation processing on an image generated from a captured image or design data which is structural representation data, or vector data included in design data which is structural representation data. For example, when structural representation data is an image, the features of the structural representation data may include at least one of a differential value of a luminance change in a predetermined direction, a direction in which luminance changes by a predetermined value or more, and an interval between pixels indicating the luminance equal to or greater than a predetermined value. That is, the feature vectors V1 to VN may include at least one of a differential value of a luminance change in a predetermined direction, a direction in which luminance changes by a predetermined value or more, and an interval between pixels indicating the luminance equal to or greater than a predetermined value as the features of the image which is the structural representation data. Further, for example, when structural representation data is vector data, the features of the structural representation data may include at least one of a vector length, a distance between vectors, and a density of vectors in a predetermined interval. That is, the feature vectors V1 to VN may include at least one of a vector length, a distance between vectors, and a density of vectors in a predetermined interval as the features of the vector data which is the structural representation data. Note that the above-described features are merely examples, and other elements may be used as the features. Further, elements other than the above ones may also be included. The classification unit 212 may perform classification processing by using both the feature of the image which is structural representation data and the feature of the vector data which is structural representation data.

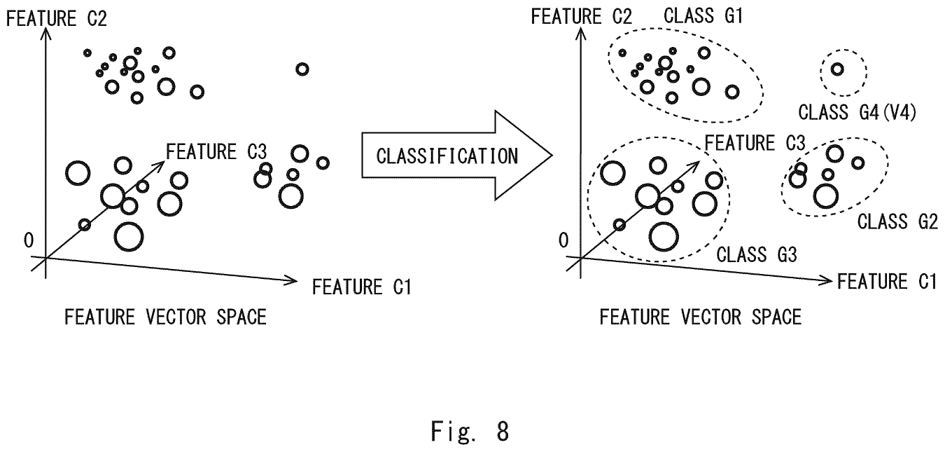

FIG. 8 is a diagram illustrating classification of structural representation data performed by the classification unit 212 in the information processing apparatus 200 according to the first embodiment. As shown in FIG. 8, the classification unit 212 classifies a plurality of pieces of structural representation data into one of a plurality of classes G1 to G4. Specifically, for example, the classification unit 212 classifies a plurality of pattern images F10 having feature vectors similar to the feature vector V1 as one class G1 in the feature vector space. Further, the classification unit 212 classifies a plurality of pattern images F10 having feature vectors similar to the feature vector V2 as one class G2 in the feature vector space. Further, similarly, in the feature vector space, the classification unit 212 classifies a plurality of pattern images F10 having feature vectors similar to the feature vector V3 as the class G3, and classifies a plurality of pattern images F10 having feature vectors similar to the feature vector V4 as the class G4. Although the number of classes G1 to G4 described above is four, it is merely an example. The number of classes may be three or less or five or more.

In this way, the classification unit 212 classifies a set of the feature vectors V1 to VN on the feature vector space so that similar vectors (close to each other on the feature vector space) are grouped into the same class. Further, the classification unit 212 groups a set of the feature vectors V1 to VN on the feature vector space so that different vectors (far apart from each other on the feature vector space) are grouped into different classes. Note that the classes into which elements are classified may include classes into which only specific structural representation data such as outliers that does not belong to other specific classes are classified. Further, there may be a case where a group in which the number of elements belonging to the group is one is generated. These are also included in the processing for classifying elements into one of the classes.

In this way, the classification unit 212 classifies a plurality of pattern images F10 into one of the classes G1 to G4.

The range of one class in the feature vector space may be set in accordance with a predetermined condition. For example, the range of each class in the feature vector space may be set in advance, or as described above, a threshold value may be set for a distance between feature vectors and then classification may be performed in accordance with whether the distance is shorter or longer than the threshold value. The classification unit 212 only needs to classify a plurality of pieces of structural representation data based on features of the structural representation data, and the classification unit 212 may classify the structural representation data by other processes. For example, the classification unit 212 may classify structural representation data by applying a rule-based processing for classifying structural representation data based on whether or not the structural representation data has a predetermined amount of features to the structural representation data. Further, the classification unit 212 may classify structural representation data by applying a trained classifier for classifying structural representation data to the structural representation data. Alternatively, the classification unit 212 may classify structural representation data by performing the above processes in combination.

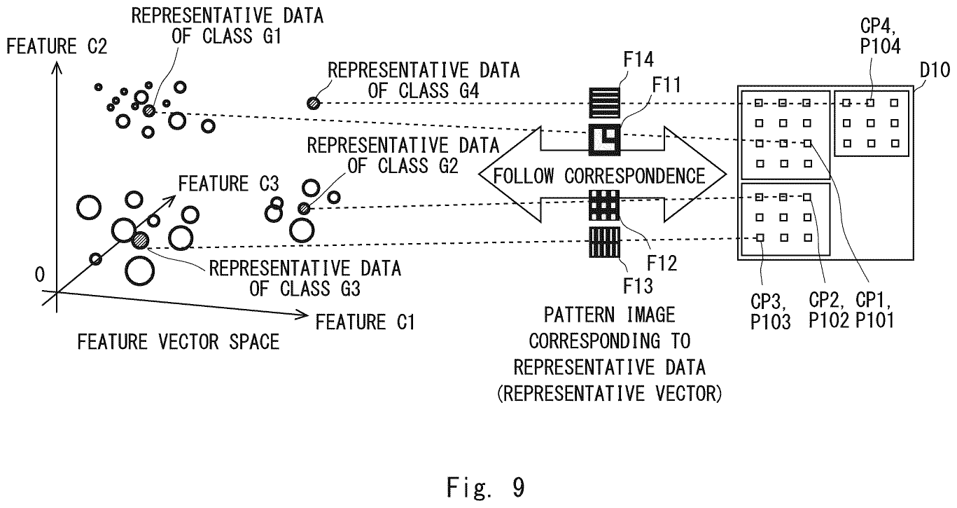

FIG. 9 is a diagram illustrating selection of representative data performed by the representative position acquisition unit 213 of the information processing apparatus 200 according to the first embodiment. As shown in FIG. 9, the representative position acquisition unit 213 selects representative data to be representative from among a plurality of pieces of structural representation data belonging to the same class. Further, the representative position acquisition unit 213 performs the above selection of representative data for a plurality of classes G1 to G4. Then the representative position acquisition unit 213 selects a plurality of pieces of representative data respectively corresponding to the plurality of classes G1 to G4. That is, the representative position acquisition unit 213 selects representative data to be representative from among a plurality of pieces of structural representation data belonging to the same class, and acquires a representative position that corresponds to the object 300 of the representative data corresponding to the class.

Specifically, the representative position acquisition unit 213 selects, as representative data, a representative image indicating a feature vector to be representative from among a plurality of pattern images F10 belonging to the same class. Further, the representative position acquisition unit 213 performs the above selection of a representative image as representative data for the plurality of classes G1 to G4. Then the representative position acquisition unit 213 selects, as representative data, a plurality of representative images respectively corresponding to the plurality of classes G1 to G4.

The representative position acquisition unit 213 may select representative data of each class under a predetermined condition. For example, the representative position acquisition unit 213 may select, as representative data, structural representation data closest to a position of the center of gravity in a feature vector space using a plurality of features as coordinate axes, from among a plurality of pieces of structural representation data included in the class. Further, the representative position acquisition unit 213 may select, as representative data, structural representation data closest to a geometric center position in a region surrounded by structural representation data located at the edge of the class, from among a plurality of pieces of structural representation data included in the class. Further, the representative position acquisition unit 213 may select, as representative data, structural representation data having a large number of pieces of structural representation data located at the same coordinates, from among a plurality of pieces of structural representation data included in the class.

Next, the representative position acquisition unit 213 associates the pattern images F10 corresponding to pieces of the representative data selected from the respective classes G1 to G4 with the positions P10 on the object 300, thereby acquiring representative positions which are positions on the object 300 for the pieces of the representative data of a plurality of the respective classes G1 to G4. The position P10 associated with the representative data is referred to as a representative position, and serves as a calibration point CP. For example, the pattern image F11 selected as representative data in the class G1 is associated with a position P101. Therefore, the position P101 is a representative position and corresponds to a calibration point CP1. Similarly, positions P102 to P104 respectively associated with pattern images F12 to F14 selected as representative data in the classes G2 to G4 are representative positions and serve as calibration points CP2 to CP4. In this way, the representative position acquisition unit 213 acquires the positions (P101 to P104) on the object 300 associated with pieces of selected representative data as representative positions. Note that the representative position acquisition unit 213 may acquire a plurality of representative positions respectively corresponding to a plurality of the classes G1 to G4, or may acquire only representative positions corresponding to some desired classes among the classes G1 to G4.

The training unit 214 trains the rendering model M10 by using, as training data, information based on the parts of the design data D10 corresponding to a plurality of representative positions (P101 to P104) and information based on the captured images CI of the parts of the object 300 corresponding to a plurality of representative positions (P101 to P104).

In other words, the training unit 214 trains the rendering model M10 by using, as training data, information based on the parts of the design data D10 corresponding to a plurality of calibration points CP (CP1 to CP4) and information based on the captured images CI of the parts of the object 300 corresponding to a plurality of calibration points CP (CP1 to CP4).

More specifically, the training unit 214 includes, in training data, information about the part of the design data corresponding to at least one representative position and information about the captured image CI of the part of the object 300 corresponding to the at least one representative position and then trains the rendering model M10. Note that, for example, in accordance with a training state of the rendering model M10, the training unit 214 may include, in the training data, information for only some representative positions among a plurality of representative positions as appropriate and then train the rendering model M10. Further, the training unit 214 may include, in the training data, information for other positions that do not belong to the representative positions acquired by the representative position acquisition unit 213 and then train the rendering model M10.

The information based on the parts of the design data D10 corresponding to the representative positions (P101 to P104) or the information based on the parts of the design data D10 corresponding to the calibration points CP (CP1 to CP4) indicates, for example, the pattern images F11 to F14 generated based on the vector data in the parts of the design data D10 corresponding to the representative positions (P101 to P104) or the pattern images F11 to F14 generated based on the vector data in the parts corresponding to the calibration points CP (CP1 to CP4). Alternatively, the information based on the parts of the design data D10 corresponding to the representative positions (P101 to P104) or the information based on the parts of the design data D10 corresponding to the calibration points CP (CP1 to CP4) may indicate the pattern images F11 to F14 generated based on the vector data in the parts of the design data D10 corresponding to the representative positions (P101 to P104) or images obtained by, for example, correcting or normalizing the pattern images F11 to F14 generated based on the vector data in the parts corresponding to the calibration points CP (CP1 to CP4) in a predetermined manner. Further, the information based on the captured images CI of the parts of the object 300 corresponding to the representative positions (P101 to P104) or the information based on the captured images CI of the parts of the object 300 corresponding to the calibration points CP (CP1 to CP4) indicates, for example, the captured images CI of the parts of the object 300 in which the patterns are formed based on the design data D10 corresponding to the representative positions (P101 to P104) or the captured images CI of the parts corresponding to the calibration points CP (CP1 to CP4). Alternatively, the information based on the captured images CI of the parts of the object 300 corresponding to the representative positions (P101 to P104) or the information based on the captured images CI of the parts of the object 300 corresponding to the calibration points CP (CP1 to CP4) may indicate the captured images CI of the parts of the object 300 in which the patterns are formed based on the design data D10 corresponding to the representative positions (P101 to P104) or images obtained by, for example, correcting or normalizing the captured images CI of the parts corresponding to the calibration points CP (CP1 to CP4) in a predetermined manner.

The captured image acquisition unit 220 acquires the captured image CI from the image capturing apparatus 100. The captured image acquisition unit 220 acquires the captured image CI based on a detection signal from the detector 170 of the image capturing apparatus 100. The captured image acquisition unit 220 associates the coordinates of the stage 140 with the intensity of the detection signal, thereby acquiring a two-dimensional image of the EUV mask 310. The captured image CI is an image acquired by capturing an image of the object 300. Note that the captured image acquisition unit 220 may acquire the captured image CI stored in advance in a storage medium such as the storage device STR from the storage device STR.

The reference image generation unit 230 generates the reference image RI based on the design data D10 of the object 300 such as the EUV mask 310. The reference image generation unit 230 may generate the reference image RI based on the design data D10 of the object 300 and the trained rendering model M10. Specifically, the reference image generation unit 230 generates the reference image RI from the design data D10 by using the rendering model M10 trained by the learning unit 210. That is, the reference image generation unit 230 generates the reference image RI by applying the rendering model M10, which is the rendering model M10 trained by the learning unit 210 and is a converter that performs conversion processing, to the design data D10.

The evaluation unit 240 evaluates the object 300 such as the EUV mask 310 based on a comparison between the reference image RI and the captured image CI.

The learning storage unit 250 may store training data used for learning in the learning unit 210. The learning storage unit 250 may store coefficients and the like of the rendering model M10 to be trained by the learning unit 210.

### Information Processing Method

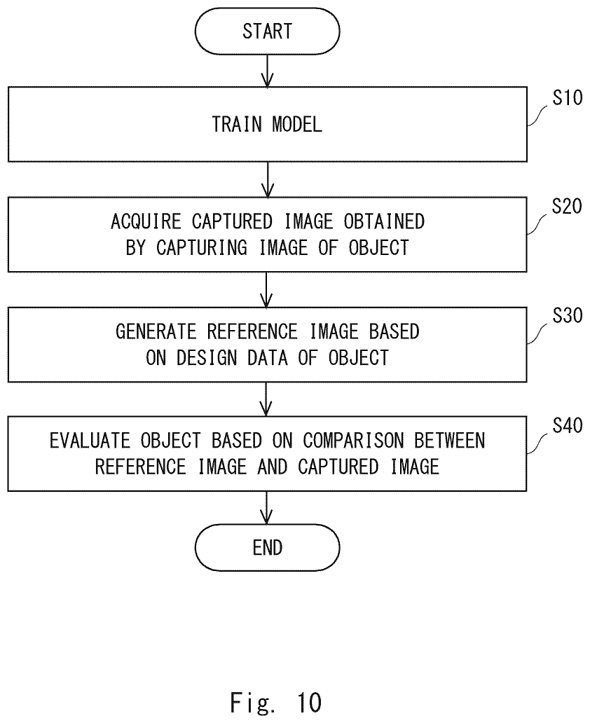

Next, an information processing method using the information processing apparatus 200 according to this embodiment will be described. FIG. 10 is a flowchart illustrating the information processing method using the information processing apparatus 200 according to the first embodiment. As shown in FIG. 10, the information processing method according to this embodiment includes Step S10 of training a model, Step S20 of acquiring the captured image CI obtained by capturing an image of the object 300, Step S30 of generating the reference image RI based on the design data D10 of the object 300, and Step S40 of evaluating the object 300 based on a comparison between the reference image RI and the captured image CI.

In Step S10, the learning unit 210 trains the rendering model M10. Specifically, the learning unit 210 classifies a plurality of pieces of structural representation data corresponding to a plurality of positions P10 of the object 300. The learning unit 210 selects representative data from each class of the plurality of pieces of structural representation data classified into a plurality of classes G1 to G4, and acquires representative positions which are positions in the object 300 associated with pieces of the representative data. Then the learning unit 210 trains the rendering model M10 by using information based on the parts of the design data D10 corresponding to the representative positions and information based on the captured images CI corresponding to the representative positions as training data.

In Step S20, the captured image acquisition unit 220 acquires, for example, the captured image CI of the object 300 captured by the image capturing apparatus 100. Note that the captured image acquisition unit 220 may acquire the captured image CI stored in the storage medium such as the storage device STR.

In Step S30, the reference image generation unit 230 generates the reference image RI based on the design data D10 of the object 300. Specifically, the reference image generation unit 230 generates the reference image RI based on the design data D1 of the object 300 and the trained rendering model M10. Note that Step S30 may be performed before Step S20 or may be performed in parallel with Step S20.

In Step S40, the evaluation unit 240 compares the reference image RI with the captured image CI, and evaluates defects or the like included in the object 300 from the difference between the two images.

### Learning Method

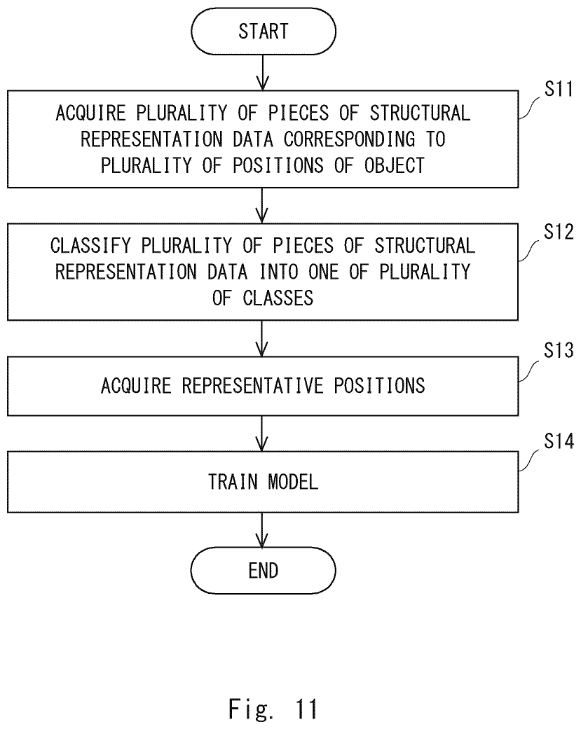

Next, a learning method using the learning unit 210 according to this embodiment will be described. FIG. 11 is a flowchart illustrating the learning method using the learning unit 210 in the information processing apparatus 200 according to the first embodiment. As shown in FIG. 11, the learning method according to this embodiment includes Step S11 of acquiring a plurality of pieces of structural representation data corresponding to a plurality of positions P10 of the object 300, Step S12 of classifying the plurality of pieces of structural representation data into one of a plurality of classes, Step S13 of acquiring representative positions, and Step S14 of training a model. Specifically, Step S13 is a step of selecting a plurality of pieces of representative data respectively corresponding to a plurality of classes and acquiring representative positions which are positions in the object 300 associated with the pieces of representative data. Specifically, Step S14 is a step of training a model using, as training data, information based on the parts of the design data D10 corresponding to a plurality of representative positions and information based on the captured images CI of the parts of the object 300 corresponding to the plurality of representative positions.

In Step S11, the structural representation data acquisition unit 211 acquires a plurality of pieces of structural representation data corresponding to a plurality of positions P10 of the object 300. Specifically, the structural representation data acquisition unit 211 generates a plurality of pattern images F10 corresponding to a plurality of positions P10 of the object 300 as structural representation data based on the design data D10 of the object 300 and acquires them.

In Step S12, the classification unit 212 acquires features of feature vectors in a plurality of pieces of structural representation data and executes clustering processing based on the features of the plurality of pieces of structural representation data. Then the classification unit 212 classifies the plurality of pieces of structural representation data into one of a plurality of classes G1 to G4. Specifically, the classification unit 212 acquires features of feature vectors in a plurality of pattern images F10 and executes clustering processing based on the features of the plurality of pattern images F10. Then the classification unit 212 classifies the plurality of pattern images F10 into one of the plurality of classes G1 to G4. Note that the classification unit 212 may perform classification by applying a rule-based processing, a trained classifier, or the like instead of or in addition to the clustering processing. As described above, the classification unit 212 only needs to classify structural representation data based on the features of a plurality of pieces of structural representation data.

In Step S13, the representative position acquisition unit 213 selects representative data to be representative from among a plurality of pieces of structural representation data belonging to the same class. The representative position acquisition unit 213 performs the above selection of representative data for a plurality of classes. That is, the representative position acquisition unit 213 selects representative data to be representative from among a plurality of pieces of structural representation data belonging to the same class, and acquires a representative position which is a position corresponding to the object 300 of the representative data corresponding to the class. In this way, the representative position acquisition unit 213 selects a plurality of pieces of representative data respectively corresponding to a plurality of classes. Specifically, the representative position acquisition unit 213 performs selection of a representative image to be representative from among a plurality of pattern images F10 belonging to the same class for a plurality of classes G1 to G4. Then the representative position acquisition unit 213 selects a plurality of representative images respectively corresponding to the plurality of classes G1 to G4. Then the representative position acquisition unit 213 acquires representative positions which are positions in the object 300 associated with a plurality of pieces of representative data (representative images) respectively corresponding to the plurality of classes G1 to G4.

Note that the representative position acquisition unit 213 may select, as the representative data, the structural representation data closest to a position of the center of gravity in a feature vector space using a plurality of features as coordinate axes, from among a plurality of pieces of structural representation data included in the class.

In Step S14, the training unit 214 trains the rendering model M10 using, as training data, information based on the parts of the design data D10 corresponding to a plurality of representative positions and information based on the captured images CI of the parts of the object 300 corresponding to the plurality of representative positions. Specifically, the training unit 214 trains the rendering model M10 using, as training data, the pattern images F10 generated based on vector data in the parts of the design data D10 corresponding to the representative positions and the captured images CI of the parts of the object 300 corresponding to the representative positions. The training unit 214 includes, in training data, information about the part of the design data D10 corresponding to at least one representative position and information about the captured image CI of the part of the object 300 corresponding to the at least one representative position and then trains the rendering model M10.

### Inspection Method

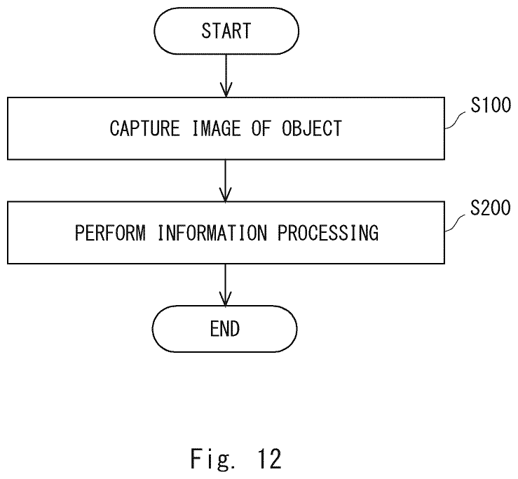

Next, an inspection method according to the first embodiment will be described. FIG. 12 is a flowchart illustrating the inspection method according to the first embodiment. As shown in FIG. 12, the inspection method according to this embodiment includes Step S100 of capturing an image of the object 300 and Step S200 of performing information processing by using the above-described information processing method.

Next, effects of this embodiment will be described. The inspection apparatus 1 according to this embodiment inspects the object 300 by using the reference image RI generated based on the design data D10 of the object 300 and the trained rendering model M10. At this time, the inspection apparatus 1 trains the rendering model M10 using, as training data, information based on the parts of the design data D10 corresponding to a plurality of representative positions and information based on the captured images CI of the parts of the object 300 corresponding to the plurality of representative positions. Note that the representative position is a position of the pattern image F10 selected as a representative from among those classified based on the features in a plurality of pattern images F10, and indicates the calibration point CP that can cover variations of the structure on the object 300. Therefore, since the trained rendering model M10 is configured or customized in accordance with the object 300, it is possible to increase the accuracy of the rendering model M10. Thus, the inspection apparatus 1 can increase the accuracy of inspection. Further, the inspection apparatus 1 can provide an information processing method in which the accuracy of inspection has been increased.

### Modified Example 1

Next, the information processing apparatus 200 according to a modified example 1 of the first embodiment will be described. In the above-described first embodiment, the structural representation data acquisition unit 211 acquires a plurality of pattern images F10 corresponding to a plurality of positions P10 of the object 300 as structural representation data based on the design data D10 of the object 300.

On the other hand, in the modified example 1, the structural representation data acquisition unit 211 acquires, as structural representation data, a plurality of captured images CI corresponding to a plurality of positions P10 of the object 300 in which the patterns are formed based on the design data D10. That is, the structural representation data acquisition unit 211 may use, as structural representation data, each of the images obtained by extracting a plurality of parts of the captured images CI. Configurations other than the above one are similar to those in the first embodiment.

Next, an information processing method according to the modified example 1 of this embodiment will be described. In the modified example 1, at Step S11 in FIG. 11 described above, the structural representation data acquisition unit 211 acquires, as structural representation data, a plurality of captured images CI corresponding to a plurality of positions P10 of the object 300. Steps other than the above one are similar to those in the first embodiment.

According to the modified example 1, the structural representation data acquisition unit 211 acquires, as structural representation data, images of a plurality of positions P10 in the captured images CI of the object 300. Therefore, since the representative position (the calibration point CP) is selected based on the actually manufactured object 300, it is possible to match the actual condition of the object 300. Configurations and effects other than the above ones are included in the description of the first embodiment.

### Modified Example 2

Next, the information processing apparatus 200 according to a modified example 2 of the first embodiment will be described. In the above-described first embodiment, the structural representation data acquisition unit 211 acquires a plurality of pattern images F10 corresponding to a plurality of positions P10 of the object 300 as structural representation data based on the design data D10 of the object 300.

On the other hand, in the modified example 2, the structural representation data acquisition unit 211 acquires a plurality of pieces of vector data corresponding to a plurality of positions P10 included in the design data D10 of the object 300 as structural representation data. That is, as shown in FIG. 6, the vector data may be used as it is as the structural representation data without being rasterized. Configurations other than the above one are similar to those in the first embodiment.

Next, an information processing method according to the modified example 2 of this embodiment will be described. In the modified example 2, at Step S11 in FIG. 11 described above, the structural representation data acquisition unit 211 acquires a plurality of pieces of vector data corresponding to a plurality of positions P10 included in the design data D10 as structural representation data. Steps other than the above one are similar to those in the first embodiment.

According to the modified example 2, the structural representation data acquisition unit 211 acquires vector data as structural representation data. Therefore, since the representative position (the calibration point CP) is selected based on a result of classification of a plurality of pieces of vector data, the representative position can be selected by a simpler process than image processing. Configurations and effects other than the above ones are included in the descriptions of the first embodiments.

Although the embodiments of the present disclosure have been described above, the present disclosure includes appropriate modifications that do not impair the objects and advantages thereof. Further, the present disclosure is not limited by the above-described embodiments.

The structural representation data acquired by the structural representation data acquisition unit 211 and the information based on the part of the design data D10 corresponding to the representative position used as training data by the training unit 214 may have the same format and property. For example, the structural representation data may be the pattern image F10, and the information based on the part of the design data D10 corresponding to the representative position which is training data may be the pattern image F10. This is an example of the above-described first embodiment.

The structural representation data acquired by the structural representation data acquisition unit 211 and the information based on the captured image CI of the part of the object 300 corresponding to the representative position used as training data by the training unit 214 may be in the same format and have the same property. For example, the structural representation data may be the captured image CI of the object 300, and the information based on the captured image CI of the part of the object 300 corresponding to the representative position which is training data may be the captured image CI. This is an example of the modified example 1 of the above-described first embodiment.

As described above, the structural representation data acquired by the structural representation data acquisition unit 211 may be in the same format and have the same property as one of the information based on the part of the design data D10 corresponding to the representative position used as training data by the training unit 214 and the information based on the captured image CI of the part of the object 300 corresponding to the representative position used as training data by the training unit 214. That is, the format and the property of the structural representation data may be the same as the format and the property of one of the information based on the part of the design data D10 corresponding to the representative position which is training data and the information based on the captured image CI of the par of the object 300 corresponding to the representative position which is training data. Thus, the structural representation data can also be utilized for training data, and hence processing is simplified.

The structural representation data acquired by the structural representation data acquisition unit 211 may be in a different format and have a different property from the format and the property of each of the information based on the part of the design data D10 corresponding to the representative position used as training data by the training unit 214 and the information based on the captured image CI of the part of the object 300 corresponding to the representative position used as training data by the training unit 214. For example, the structural representation data may be vector data included in the design data D10, and the training data may be the pattern image F10 and the captured image CI. This is an example of the modified example 2 of the above-described first embodiment. Alternatively, the structural representation data acquired by the structural representation data acquisition unit 211 may be the captured image CI, and the training data may be the pattern image F10 and the captured image CI. In this case, the captured image CI of the structural representation data may be in a format having a lower resolution than that of the captured image CI of the training data. That is, the resolution of the captured image CI as the structural representation data may be a resolution which allows the features of the captured image CI to be recognized and classification of them to be performed with a predetermined accuracy, and may be lower than that of the captured image CI as the training data. Thus, identification and acquisition of the representative positions can be advanced under low-load information processing using a lower-resolution image, and training of the rendering model M10 can be advanced based on a higher-resolution image with an enhanced learning effect.

As described above, the structural representation data acquired by the structural representation data acquisition unit 211 may be in a different format and have a different property from the format and the property of each of the information based on the part of the design data D10 corresponding to the representative position used as training data by the training unit 214 and the information based on the captured image CI of the part of the object 300 corresponding to the representative position used as training data by the training unit 214. That is, the format and the property of the structural representation data may be different from the format and the property of each of the information based on the part of the design data D10 corresponding to the representative position which is training data and the information based on the captured image CI of the part of the object 300 corresponding to the representative position which is training data. Thus, the structural representation data and the training data can be used for different purposes; for example, the structural representation data may be used as information suitable for specifying and acquiring representative positions and the training data may be used as information suitable for training the rendering model M10.

Further, combinations of the configurations of the first embodiment, the modified example 1, and the modified example 2 are also within the scope of the technical concept of the present disclosure. Furthermore, the following learning program for causing a computer to execute the learning method according to the embodiment is also within the scope of the technical concept of the present disclosure.

### Supplementary Note 1

A non-transitory computer-readable medium storing a learning program for causing a computer to perform steps of:
acquiring a plurality of pieces of structural representation data corresponding to a plurality of positions of an object;
acquiring features of feature vectors in the plurality of pieces of structural representation data and classifying the plurality of pieces of structural representation data into one of a plurality of classes based on the features of the plurality of pieces of structural representation data;
selecting representative data to be representative from among the pieces of structural representation data belonging to the same class and acquiring a representative position which is a position that corresponds to the object of the representative data corresponding to the class; and
including information based on a part of the design data of the object corresponding to at least one of the representative positions and information based on the captured image of a part of the object corresponding to the at least one of the representative positions in the training data and then training a model.

### supplementary Note 2

The medium according to supplementary note 1, wherein
in the step of acquiring the structural representation data,
the structural representation data is an image generated based on the design data of the object.

### supplementary Note 3

The medium according to supplementary note 1, wherein
in the step of acquiring the structural representation data,
the structural representation data is the captured image of the object.

### Supplementary Note 4

The medium according to supplementary note 1, wherein
in the step of acquiring the structural representation data,
the structural representation data is vector data included in the design data of the object.

### Supplementary Note 5

The medium according to any one of supplementary notes 1 to 4, wherein the feature vector includes, as the feature, at least one of a differential value of a luminance change in a predetermined direction, a direction in which luminance changes by a predetermined value or more, and an interval between pixels indicating the luminance equal to or greater than a predetermined value.

### supplementary Note 6

The medium according to any one of supplementary notes 1 to 4, wherein
in the step of acquiring the representative position,
the learning program causes the computer to select the structural representation data closest to a position of a center of gravity in a feature vector space using a plurality of features as coordinate axes as the representative data from among the plurality of pieces of structural representation data included in the class.

### Supplementary Note 7

The medium according to any one of supplementary notes 1 to 4, wherein a format and a property of the structural representation data are the same as a format and a property of one of information based on a part of the design data corresponding to the representative position which is the training data and information based on the captured image of a part of the object corresponding to the representative position which is the training data.

### Supplementary Note 8

The medium according to any one of supplementary notes 1 to 4, wherein a format and a property of the structural representation data are different from a format and a property of each of information based on a part of the design data corresponding to the representative position which is the training data and information based on the captured image of a part of the object corresponding to the representative position which is the training data.

Further, the above-described learning program includes instructions (or software codes) that, when loaded into a computer, cause the computer to perform one or more of the functions described in the embodiments. The learning program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (Registered Trademark) disc or other types of optical disc storage, a magnetic cassette, a magnetic tape, and a magnetic disk storage or other types of magnetic storage devices. The learning program may be transmitted on a transitory computer readable medium or a communication medium. By way of example, and not a limitation, transitory computer readable media or communication media can include electrical, optical, acoustical, or other forms of propagated signals.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An information processing apparatus comprising:
a learning unit configured to train a model;
an image acquisition unit configured to acquire a captured image obtained by capturing an image of an object;
a reference image generation unit configured to generate a reference image based on design data of the object; and
an evaluation unit configured to evaluate the object based on a comparison between the reference image and the captured image,
wherein the learning unit comprises:
a structural representation data acquisition unit configured to acquire a plurality of pieces of structural representation data corresponding to a plurality of positions of the object;
a classification unit configured to acquire features of feature vectors in the plurality of pieces of structural representation data and classify the plurality of pieces of structural representation data into one of a plurality of classes based on the features of the plurality of pieces of structural representation data;
a representative position acquisition unit configured to select representative data to be representative from among the pieces of structural representation data belonging to the same class and acquire a representative position which is a position that corresponds to the object of the representative data corresponding to the class; and
a training unit configured to include information based on a part of the design data corresponding to at least one of the representative positions and information based on the captured image of a part of the object corresponding to the at least one of the representative positions in the training data and then train the model, and
wherein the reference image generation unit generates the reference image based on the design data of the object and the trained model.

2. The information processing apparatus according to claim 1, wherein the structural representation data is an image generated based on the design data of the object.

3. The information processing apparatus according to claim 1, wherein the structural representation data is the captured image of the object.

4. The information processing apparatus according to claim 1, wherein the structural representation data is vector data included in the design data of the object.

5. The information processing apparatus according to claim 1, wherein the feature vector includes, as the feature, at least one of a differential value of a luminance change in a predetermined direction, a direction in which luminance changes by a predetermined value or more, and an interval between pixels indicating the luminance equal to or greater than a predetermined value.

6. The information processing apparatus according to claim 1, wherein the representative position acquisition unit selects, as the representative data, the structural representation data closest to a position of a center of gravity in a feature vector space using a plurality of features as coordinate axes, from among the plurality of pieces of structural representation data included in the class.

7. The information processing apparatus according to claim 1, wherein a format and a property of the structural representation data are the same as a format and a property of one of information based on a part of the design data corresponding to the representative position which is the training data and information based on the captured image of a part of the object corresponding to the representative position which is the training data.

8. The information processing apparatus according to claim 1, wherein a format and a property of the structural representation data are different from a format and a property of each of information based on a part of the design data corresponding to the representative position which is the training data and information based on the captured image of a part of the object corresponding to the representative position which is the training data.

9. An inspection apparatus comprising:
an image capturing apparatus configured to capture an image of the object; and
the information processing apparatus according to claim 1.

10. An information processing method comprising steps of:
training a model;
acquiring a captured image obtained by capturing an image of an object;
generating a reference image based on design data of the object; and
evaluating the object based on a comparison between the reference image and the captured image,
wherein the step of training the model comprises steps of:
acquiring a plurality of pieces of structural representation data corresponding to a plurality of positions of the object;
acquiring features of feature vectors in the plurality of pieces of structural representation data and classifying the plurality of pieces of structural representation data into one of a plurality of classes based on the features of the plurality of pieces of structural representation data;
selecting representative data to be representative from among the pieces of structural representation data belonging to the same class and acquiring a representative position which is a position that corresponds to the object of the representative data corresponding to the class; and
including information based on a part of the design data corresponding to at least one of the representative positions and information based on the captured image of a part of the object corresponding to the at least one of the representative positions in the training data and then training the model, and
wherein, in the step of generating the reference image, the reference image is generated based on the design data of the object and the trained model.

11. The information processing method according to claim 10, wherein
in the step of acquiring the structural representation data,
the structural representation data is an image generated based on the design data of the object.

12. The information processing method according to claim 10, wherein
in the step of acquiring the structural representation data,
the structural representation data is the captured image of the object.

13. The information processing method according to claim 10, wherein
in the step of acquiring the structural representation data,
the structural representation data is vector data included in the design data of the object.

14. The information processing method according to claim 10, wherein the feature vector includes, as the feature, at least one of a differential value of a luminance change in a predetermined direction, a direction in which luminance changes by a predetermined value or more, and an interval between pixels indicating the luminance equal to or greater than a predetermined value.

15. The information processing method according to claim 10, wherein
in the step of acquiring the representative position,
the structural representation data closest to a position of a center of gravity in a feature vector space using a plurality of features as coordinate axes is selected as the representative data from among the plurality of pieces of structural representation data included in the class.

16. The information processing method according to claim 10, wherein a format and a property of the structural representation data are the same as a format and a property of one of information based on a part of the design data corresponding to the representative position which is the training data and information based on the captured image of a part of the object corresponding to the representative position which is the training data.

17. The information processing method according to claim 10, wherein a format and a property of the structural representation data are different from a format and a property of each of information based on a part of the design data corresponding to the representative position which is the training data and information based on the captured image of a part of the object corresponding to the representative position which is the training data.

18. An inspection method comprising steps of:
capturing an image of an object; and
performing information processing by using the information processing method according to claim 10.

19. A learning method comprising steps of:
acquiring a plurality of pieces of structural representation data corresponding to a plurality of positions of an object;
acquiring features of feature vectors in the plurality of pieces of structural representation data and classifying the plurality of pieces of structural representation data into one of a plurality of classes based on the features of the plurality of pieces of structural representation data;
selecting representative data to be representative from among the pieces of structural representation data belonging to the same class and acquiring a representative position which is a position that corresponds to the object of the representative data corresponding to the class; and
including information based on a part of design data of the object corresponding to at least one of the representative positions and information based on a captured image of a part of the object corresponding to at least one of the representative positions in the training data and then training a model.

20. The learning method according to claim 19, wherein
in the step of acquiring the structural representation data,
the structural representation data is an image generated based on the design data of the object.

21. The learning method according to claim 19, wherein
in the step of acquiring the structural representation data,
the structural representation data is the captured image of the object.

22. The learning method according to claim 19, wherein
in the step of acquiring the structural representation data,
the structural representation data is vector data included in the design data of the object.

23. The learning method according to claim 19, wherein the feature vector includes, as the feature, at least one of a differential value of a luminance change in a predetermined direction, a direction in which luminance changes by a predetermined value or more, and an interval between pixels indicating the luminance equal to or greater than a predetermined value.

24. The learning method according to claim 19, wherein
in the step of acquiring the representative position,
the structural representation data closest to a position of a center of gravity in a feature vector space using a plurality of features as coordinate axes is selected as the representative data from among the plurality of pieces of structural representation data included in the class.

25. The learning method according to claim 19, wherein a format and a property of the structural representation data are the same as a format and a property of one of information based on a part of the design data corresponding to the representative position which is the training data and information based on the captured image of a part of the object corresponding to the representative position which is the training data.

26. The learning method according to of claim 19, wherein a format and a property of the structural representation data are different from a format and a property of each of information based on a part of the design data corresponding to the representative position which is the training data and information based on the captured image of a part of the object corresponding to the representative position which is the training data.
